(19) United States
(12) Patent Application Publication
(10) Pub. No.: US 2005/0205339 A1
(43) Pub. Date: Sep. 22, 2005

(54) Steering control apparatus for a vehicle

(76) Inventors: Hiroaki Aizawa, Anjo city (JP); Hiroaki Niino, Toyota city (JP); Minekazu Momiyama, Chiryu city (JP); Hiroaki Kato, Hekinan city (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/067,719

(22) Filed: Mar. 1, 2005

(30) Foreign Application Priority Data
Mar. 2, 2004 (JP) 2004-057804
Mar. 2, 2004 (JP) 2004-057805

(51) Int. Cl. B60K 17/34

(52) U.S. Cl. 180/443

(57) ABSTRACT

A steering control apparatus is provided for controlling a steered wheel angle of a wheel to be steered, wherein braking force applied to each of at least a pair of right and left wheels of the vehicle is estimated, and the braking force is modified on the basis of a variation of braking force resulted from a varying load applied to each of the wheels, when the vehicle is turning. And, a steered wheel angle of the wheel to be steered, or steering torque, is provided to cancel a moment about a gravity center of the vehicle, on the basis of the modified braking force.

This application claims priority under 35 U.S.C. Sec. 119 to Nos. 2004-057804 and 2004-057805 filed in Japan on Mar. 2, 2004, the entire contents of which are herein incorporated by reference.

### BACKGROUND OF THE INVENTION

1. Field of the Invention

The present invention relates to a steering control apparatus for a vehicle, particularly relates to an apparatus for controlling a steered wheel angle (tire angle) of a wheel to be steered, or applying a steering torque thereto, in response to steering operation of a vehicle driver, with respect to front or rear wheels of the vehicle to be steered.

2. Description of the Related Arts

In the United States Publication No. US2002/0013646 A1 (corresponding to Japanese Patent Laid-open Publication No. 2001-334947), for example, there is disclosed a motor vehicle steering system which is capable of controlling the attitude of a motor vehicle by controlling a steering mechanism. It is described in the Publication that in response to the detection of the actuation of the braking mechanism, the steering control circuit additionally turns the steerable wheels of the motor vehicle by a control steering angle toward one of the left and right wheels having a lower wheel speed on the basis of a result of judgement by the speed comparing circuit on condition that the speed difference between the left and right wheels exceeds the predetermined threshold value. With respect to a so-called “μ-split road”, it is explained that a road having significantly different friction coefficients with respect to left and right wheels of the motor vehicle. In that publication, the speed difference between the left and right wheels is employed as a reference for judging the “μ-split road”. And, a method for estimating a coefficient of friction of a road surface is described in the U.S. Pat. No. 6,447,076 B1 (corresponding to Japanese Patent Laid-open Publication No. 2000-108863).

According to the system as disclosed in the United States Publication No. US2002/0013646, it is so controlled that when the braking operation is performed on the μ-split road, the yaw moment acting on the motor vehicle at the initial stage of the braking operation is suppressed with a satisfactory responsiveness by the addition of the predetermined control steering angle for turning the front wheels toward the lower-speed wheel. In other words, by performing a so-called counter-steer control, the controlled yaw moment is applied in a reverse direction to the vehicle, to achieve a stability control of the vehicle.

As described above, in the case where the vehicle is running on a road surface with different coefficients of friction, with a pair of (right and left) wheels to be steered being positioned on the surface of different coefficients of friction from each other, respectively, if a braking operation is performed to each wheel to perform a so-called “μ-cross over braking”, it is required to perform an action properly reflecting the road surface condition. In the case where a steered wheel angle of the wheel to be steered is controlled to cancel a moment about a gravity center of the vehicle, which is caused during the μ-cross over braking operation of the vehicle, for example, braking force difference will be caused between the road conditions on which the wheels are placed. Therefore, a steering control is required for canceling the braking force difference.

In the case where the braking operation is being performed when the vehicle is turning, a varying load applied to each wheel of the right and left wheels results in causing a braking force difference, which will be likely to cause an excessive steering behavior. Therefore, such a steering control for responding to it is required. Furthermore, in such a combined state that the turning operation and μ-cross over braking operation are occurring at the same time, the braking force difference resulted from the varying load during the turning operation is required to be clearly distinguished, before the steering control is performed. Therefore, it is required to solve a problem much more difficult than the problem as raised with respect to the prior steering control apparatus including the one disclosed in the United States Publication No. US2002/0013646.

Or, in the case where the steering control is being performed during the μ-cross over braking operation of the vehicle, for example, if the steered wheel angle of the wheel to be steered is varied, a moment balance about the gravity center of the vehicle will be changed from the one before the steering control is performed. Therefore, it is required to perform an action reflecting the changed state. Although it has been described in the United States Publication No. US2002/0013646 that the steering angle is set to be variable in response to the braking force difference between the right and left wheels, it is silent about the steering control reflecting the moment balance as described before.

### SUMMARY OF THE INVENTION

Accordingly, it is an object of the present invention to provide a steering control apparatus capable of maintaining an appropriate stability of a vehicle, with a steering control performed properly, even in the case where a braking operation is performed when the vehicle is turning.

And, it is another object of the present invention to provide a steering control apparatus capable of maintaining an appropriate stability of a vehicle, with a steering control reflecting a moment balance about a gravity center of the vehicle, which is resulted from a variation of steered wheel angle of a wheel to be steered.

In accomplishing the above object, the steering control apparatus includes a steering control device for controlling a steered wheel angle of a wheel to be steered in response to steering operation of a vehicle driver, a braking force estimation device for estimating a braking force applied to each of at least a pair of right and left wheels of the vehicle, respectively, and a lateral acceleration detection device for detecting a lateral acceleration of the vehicle. A braking force modification device is provided for calculating a variation of braking force resulted from a varying load applied to each of the right and left wheels on the basis of the lateral acceleration detected by the detection device, when the vehicle is turning, and provided for modifying the braking force estimated by the braking force estimation device, on the basis of the variation of braking force. And, a steered wheel angle setting device is provided for setting the steered wheel angle of the wheel to be steered, to cancel a moment about a gravity center of the vehicle, on the basis of the braking force modified by the braking force modification device.

Or, the steering control apparatus may include a steering torque applying device for applying a steering torque to a wheel to be steered in response to steering operation of a vehicle driver, a braking force estimation device for estimating a braking force applied to each of at least a pair of right and left wheels of the vehicle, respectively, and a lateral acceleration detection device for detecting a lateral acceleration of the vehicle. A braking force modification device is provided for calculating a variation of braking force resulted from a varying load applied to each of the right and left wheels on the basis of the lateral acceleration detected by the detection device, when the vehicle is turning, and provided for modifying the braking force estimated by the braking force estimation device, on the basis of the variation of braking force. And, a steering torque setting device is provided for setting the steering torque of the wheel to be steered, to cancel a moment about a gravity center of the vehicle, on the basis of the braking force modified by the braking force modification device.

In the steering control apparatuses as described above, a vehicle behavior determination device may be provided for determining at least an understeer state of the vehicle. And, the braking force modification device is preferably adapted to modify the variation of braking force resulted from the varying load applied to each of the right and left wheels, on the basis of the understeer state of the vehicle determined by the vehicle behavior determination device, to modify the braking force applied to each wheel.

The braking force modification device may be adapted to modify the variation of braking force resulted from the varying load applied to each of the right and left wheels, by a relatively large amount, when the understeer state of the vehicle determined by the vehicle behavior determination device is in the vicinity of a neutral-steer state of the vehicle, and the braking force modification device may be adapted to modify the variation of braking force by a smaller amount, with the understeer state of the vehicle being varied to be larger.

Or, the braking force modification device may be adapted to modify the variation of braking force resulted from the varying load applied to each of the right and left wheels, to be of such a predetermined value that the understeer state of the vehicle determined by the vehicle behavior determination device is in the vicinity of the neutral-steer state of the vehicle.

The steering control apparatus may include a steering control device for controlling a steered wheel angle of a wheel to be steered in response to steering operation of a vehicle driver, a braking force estimation device for estimating a braking force applied to each of at least a pair of right and left wheels of the vehicle, respectively, and a lateral force estimation device for estimating a lateral force applied to each of the right and left wheels. A slip angle calculation device is provided for calculating a slip angle for each of the right and left wheels, to cancel a moment about a gravity center of the vehicle caused by the braking force and lateral force applied to each of the right and left wheels, on the basis of the results estimated by the braking force estimation device and the lateral force estimation device. And, a steered wheel angle setting device is provided for setting the steered wheel angle of the wheel to be steered, on the basis of the slip angle calculated by the slip angle calculation device.

Or, the steering control apparatus may include a steering torque applying device for applying a steering torque to a wheel to be steered in response to steering operation of a vehicle driver, a braking force estimation device for estimating a braking force applied to each of at least a pair of right and left wheels of the vehicle, respectively, and a lateral force estimation device for estimating a lateral force applied to each of the right and left wheels. A slip angle calculation device is provided for calculating a slip angle for each of the right and left wheels, to cancel a moment about a gravity center of the vehicle caused by the braking force and lateral force applied to each of the right and left wheels, on the basis of the results estimated by the braking force estimation device and the lateral force estimation device. And, a steering torque setting device for setting the steering torque of the wheel to be steered, on the basis of the slip angle calculated by the slip angle calculation device.

In the steering control apparatuses as described above, the slip angle calculation device preferably includes a recurrent calculation device for performing at least one cycle of recurrent calculation to the slip angle calculated by the slip angle calculation device, to substitute the result calculated by the recurrent calculation device for the slip angle calculated by the slip angle calculation device.

### BRIEF DESCRIPTION OF THE DRAWINGS

The above stated object and following description will become readily apparent with reference to the accompanying drawings, wherein like referenced numerals denote like elements, and in which:

FIG. 1 is a schematic block diagram showing a steering control apparatus according to an embodiment of the present invention;

FIG. 2 is a block diagram showing an embodiment of a steering control system according to an embodiment of the present invention;

FIG. 3 is a block diagram showing an embodiment of a steering control system including an active counter-steer control according to an embodiment of the present invention;

FIG. 4 is a plan view showing a turning operation of a vehicle, according to an embodiment of the present invention;

FIG. 5 is a diagram showing an example of a map for setting a varying load distribution coefficient (Ku) in response to a vehicle behavior, according to an embodiment of the present invention;

FIG. 6 is a flowchart showing operation of active counter-steer control according to an embodiment of the present invention;

FIG. 7 is a flowchart showing operation of calculating a desired angle of steered wheel for an actuator at the time of an active counter-steer control according to an embodiment of the present invention;

FIG. 8 is a schematic block diagram showing a steering control apparatus according to another embodiment of the present invention;

FIG. 9 is a block diagram showing an embodiment of a steering control system according to another embodiment of the present invention;

FIG. 10 is a block diagram showing an embodiment of a steering control system including an active counter-steer control according to another embodiment of the present invention;

FIG. 11 is a block diagram showing an embodiment of a steering control system including an active counter-steer control according to a further embodiment of the present invention;

FIG. 12 is a plan view showing a state of a vehicle with braking force applied to one wheel to be steered, according to a further embodiment of the present invention;

FIG. 13 is a plan view showing a state of a vehicle with a steering control being performed for balancing the braking force differences among four wheels and a moment about a gravity center of the vehicle as shown in FIG. 4, according to a further embodiment of the present invention;

FIG. 14 is a flowchart showing operation of active counter-steer control according to a further embodiment of the present invention;

FIG. 15 is a flowchart showing operation of calculating a desired angle of steered wheel for an actuator at the time of an active counter-steer control according to a further embodiment of the present invention;

FIG. 16 is a block diagram showing an embodiment of a steering control system including an active counter-steer control according to a yet further embodiment of the present invention; and

FIG. 17 is a flowchart showing operation of calculating a counter-steer assisting torque at the time of an active counter-steer control according to a yet further embodiment of the present invention.

### DESCRIPTION OF THE PREFERRED EMBODIMENTS

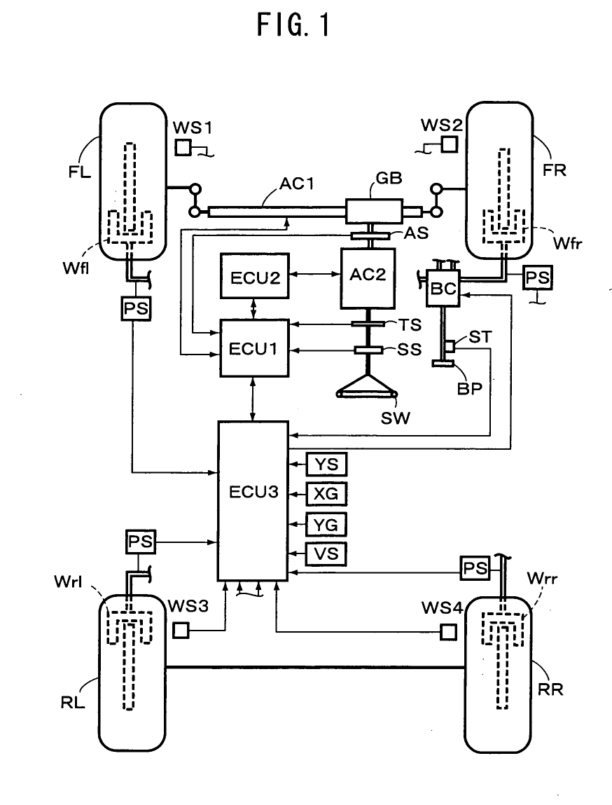

Referring to FIG. 1, there is schematically illustrated a block diagram of a steering control apparatus according to an embodiment of the present invention. FIG. 1 illustrates an overall structure of the vehicle including the steering control apparatus, wherein a steering system includes an electric power steering system, an active steering system and a variable transmitting ratio control system. According to the electric power steering system, an actuator is controlled in response to steering operation of the vehicle driver, to steer wheels to be steered, thereby to reduce steering force required for the steering operation by the vehicle driver. In the active steering system, the steered wheel angle (tire angle) of a wheel to be steered (hereinafter, referred to as steered wheel) is controlled freely in response to steering operation of the vehicle driver, so that an active steering control for increasing or decreasing the steered wheel angle (tire angle) to the steering operation angle (steering angle, or handle angle) can be achieved. And, according to the variable transmitting ratio control system, there is disposed a variable transmitting ratio device in a steering operation transmitting system for connecting a steering wheel and the steered wheel, to make the transmitting ratio to be variable.

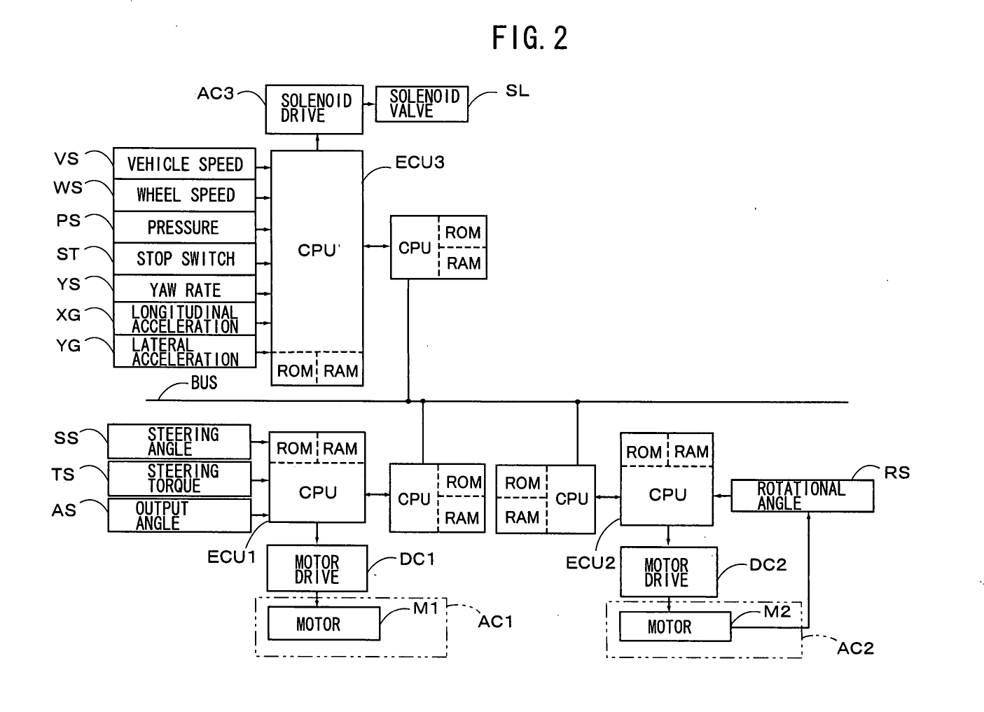

As shown in FIG. 1, between the right and left front wheels FL and FR to be steered, there is disposed an actuator AC1 for performing a power steering control, which is controlled by a steering control unit ECUL. And, an actuator AC2 for performing a variable transmitting ratio control is connected to a steering wheel SW, and provided with a steering angle sensor SS for detecting a steering angle (or, handle angle) of the steering wheel SW, a steering torque sensor TS for detecting a steering torque of the steering wheel SW, and an output angle sensor AS for detecting an output of the actuator AC2. The actuator AC2 is connected to the actuator AC1 through a steering gear box GB, and controlled by a variable transmitting ratio control unit ECU2, which can be communicated with the steering control unit ECU1 by sending and receiving bidirectional signals. The components as described above are connected as shown in FIG. 2, and each unit will be explained later in detail.

Next, with respect to a braking system according to the present embodiment, wheel brake cylinders Wfl, Wfr, Wrl, Wrr are operatively associated with the wheels FL, FR, RL, RR of the vehicle, respectively, and which are fluidly connected to the hydraulic braking pressure control device BC. This device BC includes a plurality of solenoid valves and an automatic hydraulic pressure generating source, e.g., pressure pump or the like, to provide a hydraulic pressure circuit which can be pressurized automatically. As the device BC is the same as an ordinary device, and the present embodiment is not characterized in a specific hydraulic braking pressure control, a drawing and explanation thereof are omitted herein. In FIG. 1, the wheel FL designates the wheel at the front left side as viewed from the position of a driver's seat, the wheel FR designates the wheel at the front right side, the wheel RL designates the wheel at the rear left side, and the wheel RR designates the wheel at the rear right side.

As shown in FIG. 1, in the vicinity of the wheels FL, FR, RL and RR, there are provided wheel speed sensors WS1 to WS4 respectively, which are connected to a brake control unit ECU3, and by which a signal having pulses proportional to a rotational speed of each wheel, i.e., a wheel speed signal is fed to the brake control unit ECU3. Also, a vehicle speed sensor VS is provided for detecting a vehicle speed, which may be differentiated to provide a vehicle deceleration. Instead, the vehicle speed may be estimated on the basis of the wheel speed which is detected by a wheel speed sensor (not shown) disposed in the vicinity of each wheel. There are also provided a stop switch ST which turns on when the brake pedal BP is depressed, and turns off when the brake pedal BP is released, a longitudinal acceleration sensor XG for detecting a vehicle longitudinal acceleration Gx, a lateral acceleration sensor YG for detecting a vehicle lateral acceleration Gy, a yaw rate sensor YS for detecting a yaw rate γ of the vehicle and so on. These are electrically connected to the brake control unit ECU3.

FIG. 2 shows an overall system of the present invention, wherein the steering control system, variable transmitting ratio control system and braking control system are connected with each other through the communication bus, so that each system may hold each information commonly. The steering control system includes the steering control unit ECU1 which is provided with CPU, ROM and RAM for the steering control, and to which the steering angle sensor SS, steering torque sensor TS and output angle sensor AS are connected, and also an electric motor M1 is connected through a motor drive circuit DC1. The variable transmitting ratio control system includes the variable transmitting ratio control unit ECU2 which is provided with CPU, ROM and RAM for the variable transmitting ratio control, and to which an electric motor M2 is connected through a motor drive circuit DC2. The electric motor M2 is provided with a rotational angle sensor RS for detecting a rotational (turning) angle of the motor M2, and connected to feed a rotational angle signal into the variable transmitting ratio control unit ECU2. And, the braking control system is adapted to perform the anti-skid control (ABS) or the like, and includes the braking control unit ECU3 which is provided with CPU, ROM and RAM for the braking control, and to which a vehicle speed sensor VS, the wheel speed sensors WS, hydraulic pressure sensors PS, stop switch ST, yaw rate sensor YS, longitudinal acceleration sensor XG, and lateral acceleration sensor YG are connected, and also solenoid valves SL are connected through a solenoid drive circuit AC3. Those control units ECU1-ECU3 are connected to the communication bus through a communication unit provided with CPU, ROM and RAM for the communication, respectively. Accordingly, the information required for each control system can be transmitted by other control systems.

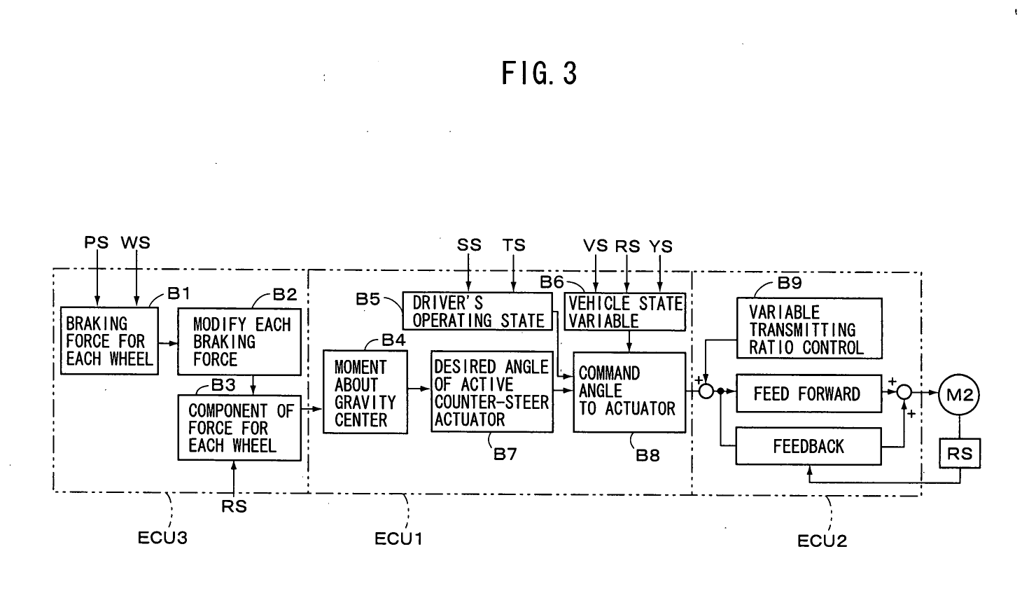

The control units ECU1-ECU3 as described above are provided with a control block as shown in FIG. 3. At the outset, the braking control unit ECU3 includes a braking force estimation block (B1) for estimating a braking force applied to each wheel, a braking force modification block (B2) for modifying the estimated braking force to each wheel, and a component of force estimation block (B3) for estimating a component of the braking force for each wheel in a lateral (right-left) direction and a longitudinal (front-rear) direction of the vehicle, on the basis of the modified braking force for each wheel. And, the steering control unit ECU1 includes a driver's operating state calculation block (B5) and vehicle state variable estimation block (B6). On the basis of the results of calculation by those blocks (B5) and (B6), an actuating angle for actuating the actuator AC2 is calculated at an actuator command angle calculation block (B8). The drivers operating state calculation block (B5) is connected with the steering angle sensor SS and steering torque sensor TS. The vehicle state variable estimation block (B6) is connected with the vehicle speed sensor VS, rotational angle sensor RS, yaw rate sensor YS or the like. Furthermore, in the steering control unit ECU1, a moment calculation block (B4) is provided for calculating a moment about a gravity center of the vehicle, which is created on each wheel, on the basis of the results estimated at the component of force estimation block (B3). And, an actuator desired angle setting block (B7) is provided for setting a desired angle to the actuator for the active counter-steer control, on the basis of the result calculated at the moment calculation block (B4). At the actuator command angle calculation block (B8), calculated is a command value of angle for actuating the actuator AC2 to perform the counter-steer. Then, according to the variable transmitting ratio control unit ECU2, a command value provided at a variable transmitting ratio control block (B9) is added to the command value provided at the actuator command angle calculation block (B8) as described before. In response to the added result, the feed forward control and feed back control are performed for controlling the electric motor M2, the detailed explanation of which is omitted herein, because the variable transmitting ratio control is not directly related to the present invention.

According to the braking force estimation block (B1), the braking force applied to each wheel can be obtained on the basis of the wheel cylinder pressure detected by the pressure sensor PS and the wheel acceleration obtained by differentiating the result detected by the wheel speed sensor WS. The wheel cylinder pressure may be detected directly by the pressure sensor PS, or may be estimated on the basis of the controlling amount, and increasing or decreasing controlling time for the brake actuator. Also, in the case where the hydraulic brake apparatus is not employed, instead a regenerative braking control is employed, for example, the braking force can be estimated on the basis of the controlling amount. At the component of force estimation block (B3), the component of the braking force for each wheel, in the right-left direction and front-rear direction of the vehicle, can be estimated on the basis of the braking force for each wheel estimated at the braking force estimation block (B1) and modified at the braking force modification block (B2), and on the basis of the rotational angle of the motor M2 detected by the rotational angle sensor RS corresponding to the actually steered wheel angle of each wheel. Or, instead of the actually steered wheel angle of each wheel, a slip angle may be used.

The braking force applied to each wheel and estimated at the braking force estimation block (B1) includes a varying component of braking force resulted from a difference of road condition such as coefficient of friction (μ) of road surface, on which each wheel is placed, which component is abbreviated hereinafter, as braking force due to coefficient of friction, and a varying component of braking force resulted from a varying load applied to each wheel when the vehicle is turning, which component is abbreviated hereinafter, as braking force due to varying load. The component of braking force due to varying load as described above is divided at the braking force modification block (B2) to be modified, with a weight given thereto in accordance with the turning state of the vehicle, as follows.

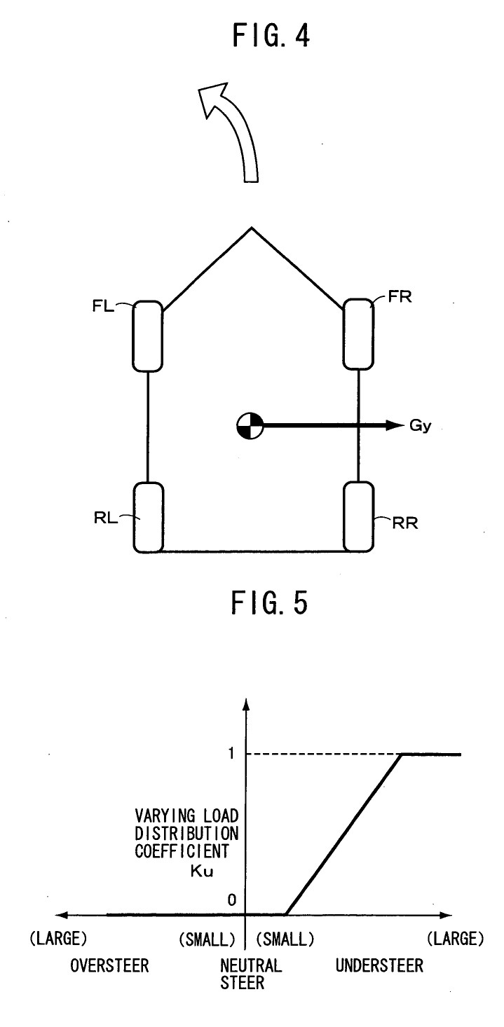

In the case where a braking force control is made when a vehicle is turning in a direction of a blank arrow as shown in FIG. 4, to cause a lateral acceleration (Gy), the load applied to each of the wheels Fr and FL to be steered will be obtained as follows:
Mfr=mfr+My·Gy·H/T p-cross (1)
Mfl=mfl−My·Gy ·H/T p-cross (2)
where “H” is a height of the gravity center of the vehicle, “T” is a tread, “Mf” is a load of front axle, “Gy” is a lateral acceleration, “Mfr” is a wheel load of the wheel FR including the varying load, “Mfl” is a wheel load of the wheel FL including the varying load, “mfr” is a wheel load of the wheel FR excluding the varying load, and “mfl” is a wheel load of the wheel FL excluding the varying load. As the moment is not influenced so much by the varying load in the longitudinal direction of the vehicle, a longitudinal acceleration “Gx” is neglected herein.

If a rate (i.e., moving rate of load) of the braking force due to varying load to the braking force due to coefficient of friction is used, there can be such a relationship that (braking force due to coefficient of friction)={(total braking force)+(moving rate of load)×(braking force due to varying load)}. Therefore, if the moving rates of load for the wheels FR and FL are indicated by “Rfr” and “Rfl”, respectively, those equations can be rewritten as follows:

$$\begin{matrix}\begin{matrix}Rfr = 1 - Mfr / \{ ( Mfr + Mf1 ) / 2 \} \\ = ( mf1 - mfr - 2 Mf \cdot Gy \cdot H / T ) / ( mfr + mf1 )\end{matrix} & ( 3 ) \\ \begin{matrix}Rf1 = 1 - Mf1 / \{ ( Mfr + Mf1 ) / 2 \} \\ = ( mfr - mf1 + 2 Mf \cdot Gy \cdot H / T ) / ( mfr + mf1 )\end{matrix} & ( 4 )\end{matrix}$$

Then, in the equations (3) and (4), provided that [mfr=mfl] and [(mfr+mfl)=Mf], the moving rate of load (Rfr) equals to (−2Gy·H/T), and the moving rate of load (Rfl) equals to (+2Gy·H/T), and the same is applied to the rear wheels RR and RL, the following equations (5)-(8) may be obtained. In these equations, the total braking force of each wheel is indicated by “ffr”, “ffl”, “frr”, “frl”, and the braking force due to coefficient of friction is indicated by “F₁fr”, “F₁fl”, “F₁rr”, “F₁rl”, wherein the last two letters “fr”, “fl”, “rr”, “rl” indicate the wheels FR, FL, RR, RL, respectively. “Tf” is a tread of front axle, and “Tr” is a tread of rear axle.
F₁fr=ffr−(2Gy·H/Tf)·F₁fr (5)
F₁fl=ffl+(2Gy·H/Tf)·F₁fl (6)
F₁rr=frr−(2Gy·H/Tr)·F₁rr (7)
F₁rl=frl+(2Gy·H/Tr)·F₁rl (8)

From the equations (5)-(8), the braking force due to coefficient of friction for each wheel is obtained as follows:
F₁fr=ffr/(1+2Gy·H/Tf) p-cross (9)
F₁fl=ffl/(1−2Gy−H/Tf) (10)
F₁rr=frr/(1+2Gy·H/Tr) p-cross (11)
F₁rl=frl/(1−2Gy·H/Tr) (12)

Therefore, provided that the braking force due to varying load for each wheel is indicated by “F₂fr”, “F₂fl”, “F₂rr”, “F₂rl”, respectively, then “F₂fr” equals to (ffr-F₁fr), “F₂fl” equals to (ffl-F₁fl), “F₂rr” equals to (frr-F₁rr), and “F₂rl” equals to (frl-F₁rl). Then, using a varying load distribution coefficient (Ku), the modified braking force for each wheel can be indicated as follows:
Ffr=F₁fr+Ku·F₂fr (13)
Ffl=F₁fl+Ku·F₂fl (14)
Frr=F₁rr+Ku·F₂rr (15)
Frl=F₁rl+Ku·F₂rl (16)

The varying load distribution coefficient (Ku) may be set to be varied in accordance with the vehicle behavior (particularly, understeer state), according to a map as shown in FIG. 5, for example. Or, it may be set in advance, so that the vehicle behavior in the turning operation will be shifted from a neutral-steer state to a slight understeer state. If the vehicle behavior in the turning operation is not specific, the coefficient (Ku) may be set to be zero. With respect to the understeer state, it can be determined on the basis of a difference between the actual yaw rate detected by the yaw rate sensor YR and a normal yaw rate.

At the moment calculation block (B4) as shown in FIG. 3, therefore, the moment about the gravity center of the vehicle is calculated on the basis of the braking force and lateral force (caused by the actual steered wheel angle) for each wheel as described before, to obtain the steered wheel angle for producing the lateral force corresponding to the moment. Supposing that the initial steered wheel angle is set to be zero for the purpose of easy understanding, the moment (Mo) applied to the vehicle by the braking operation is obtained as follows:
Mo=(Ffl+Frl−Ffr−Frr)·(T/2) (17)

Then, at the actuator desired angle setting block (B7), a slip angle (θ) for canceling the moment Mo can be obtained on the basis of the following equation (18) indicative of a moment balance, according to the following equation (19), to be set as the steered wheel angle.
θ·Ksf·Lf=Mo (18)
θ=Mo/(Ksf·Lf) (19)
where “Ksf” is a converting coefficient for slip angle and lateral force, and “Lf” is a distance between the gravity center and the front axle.

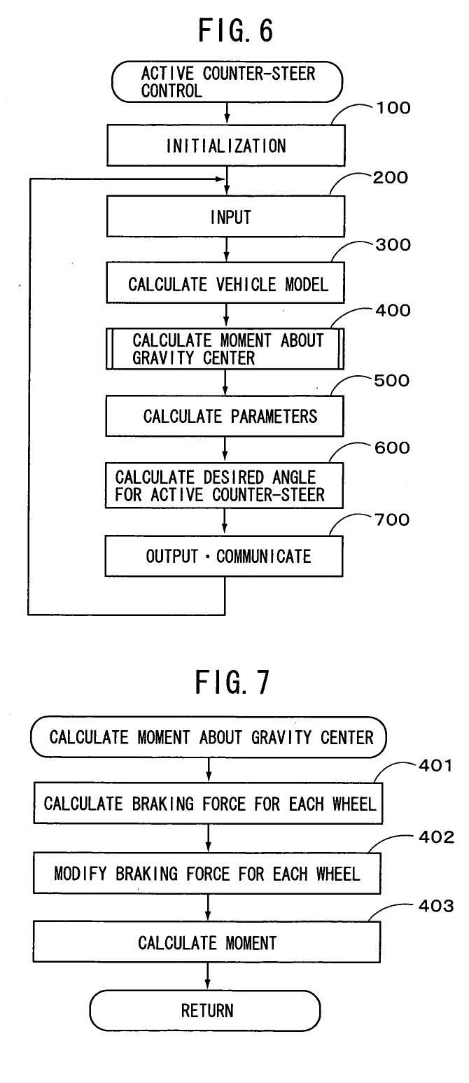

The steering control apparatus as constituted above is actuated to perform the active counter control in response to braking operation, when the vehicle is running on the μ-split road, for example, according to flowcharts as shown in FIGS. 6 and 7. At the outset, with respect to the steering control, the program provides for initialization of the system at Step 100, and the sensor signals are input, so that the steered wheel angle, vehicle speed, longitudinal acceleration, lateral acceleration, yaw rate or the like are read at Step 200, and various data calculated by the braking control unit ECU3 are read as well, through the communication signals. Then, the program proceeds to Step 300 where a vehicle model is calculated, while its explanation is omitted herein. Next, at Step 400, is calculated the moment about the gravity center, as described later in detail. Then, after various parameters are calculated at Step 500, the program proceeds to Step 600 where the desired value for performing the active counter-steer control by the actuator AC2 is calculated. Consequently, the program proceeds to Step 700 where output process is made, and the information transmitting process is made.

FIG. 7 shows the calculation of the moment about the gravity center of the vehicle made at Step 400, wherein the braking force is estimated for each wheel at Step 401. Then, the braking force for each wheel is modified at Step 402. For example, the varying load distribution coefficient (Ku) may be set to vary in accordance with vehicle behavior in the turning operation (understeer state), as described before. Or, it may be set in advance, so that the vehicle behavior in the turning operation will be shifted from the neutral-steer state to the slight understeer state. If the vehicle behavior in the turning operation indicates a desired characteristic, the coefficient (Ku) may be set to be zero. And, if the tendency of understeer state is relatively high, the coefficient (Ku) may be set to be Ku=0.4 for example, so as to be shifted to the slight understeer state.

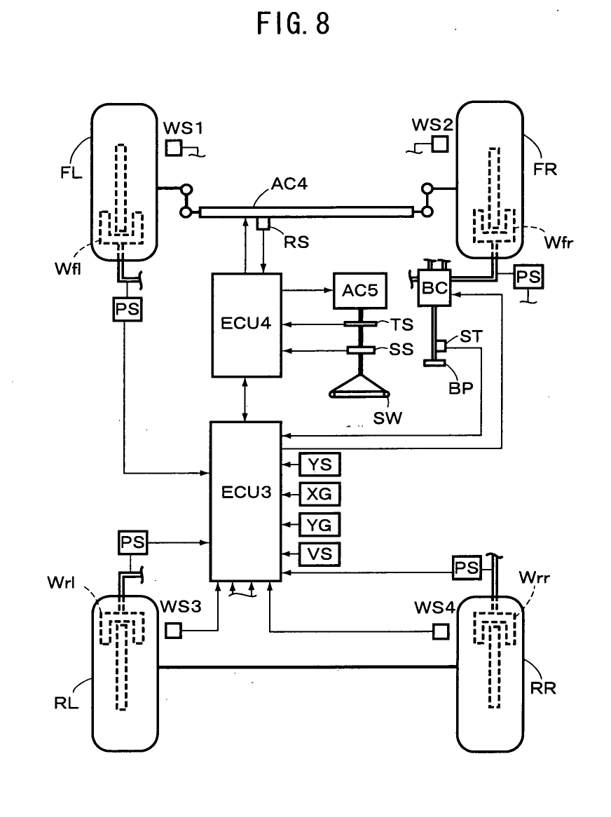

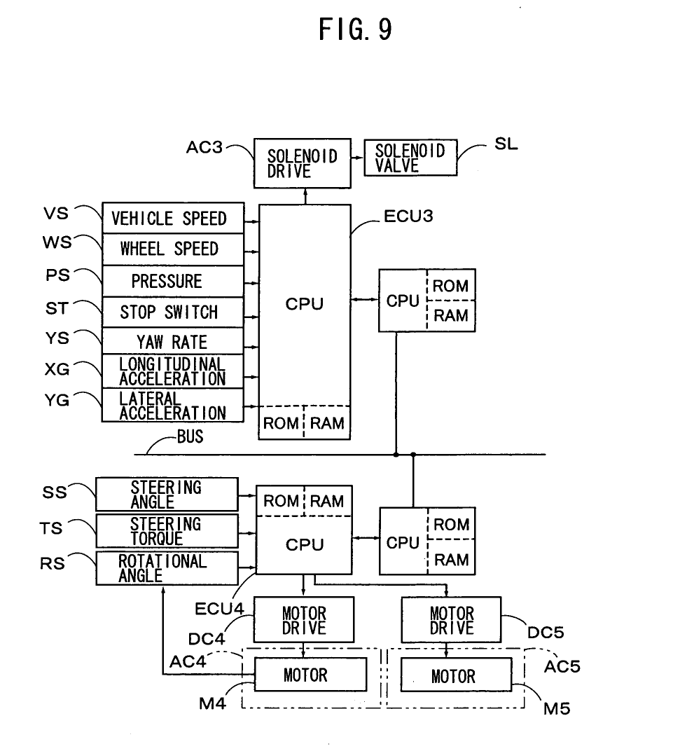

FIGS. 8 and 9 relate to another embodiment of the present invention, wherein the steering control system is constituted by a so-called steer-by-wire system, and performs the electric power steering function and the active steering function as described before, and is provided with an actuator AC4 similar to the actuator AC1 as shown in FIG. 1. The steering angle detected by the steering angle sensor SS in response to operation of the steering wheel SW by the vehicle driver, and the steering torque detected by the steering torque sensor TS are fed to the steering control unit ECU4. On the basis of those signals and the vehicle state signals (vehicle speed or the like), electric current is provided for actuating the motor (M4 in FIG. 9) in the actuator AC4, to control the steered wheel angle (tire angle) of the front wheels FL and FR. In order to apply a steering reaction force to the operation of the steering wheel SW, there is provided a reaction actuator AC5 having the motor (M5 in FIG. 9). The braking control system and the like of the present embodiment are substantially the same as those of the embodiment as shown in FIGS. 1 and 2, the explanation of them is omitted herein, with the same reference numerals given to substantially the same elements as shown in FIGS. 1 and 2. However, a steering control unit ECU4 is different from the steering control unit ECU1 as shown in FIG. 3.

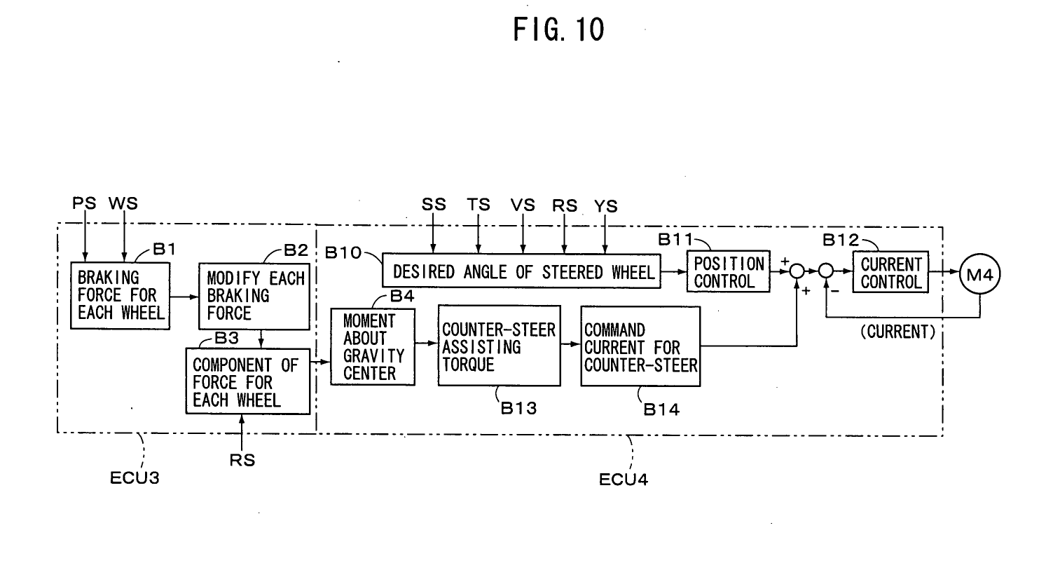

As shown in FIG. 10, the steering control unit ECU4 has a block (B10) which includes the blocks (B5) and (B6) as shown in FIG. 3, while it may be constituted in the same structure of the block (B4) as shown in FIG. 3. With respect to the blocks following it, the present embodiment includes a block (B11) for performing a position feedback control to make a deviation between the desired value and the actual value for the steered wheel angle is controlled to be zero, and a block (B12) for performing a current feedback control to achieve a torque control for obtaining the required output of steering torque. Then, it is so constituted that the current command value for performing the desired steering control with respect to the electric motor M4 is added by the current command value for performing the counter-steer, which is calculated as follows:

At the outset, a counter-steer assisting steering torque (τct) is calculated at a block (B13), and converted into the current command value for performing the counter-steer at a block (B14). According to the present embodiment, the counter-steer assisting steering torque (τct) is calculated not only on the basis of the braking force difference between the right and left wheels, but also on the basis of variation of balance of the moment about the gravity center of the vehicle, which is determined by the braking force actually applied to each wheel, and which is set on the basis of [θ=Mo/(Ksf·Lf)], as follows:
τct=θ·Kst (20)
τct=θ·Kst+Kd·(dθ/dt)·Kst (21)
where “Kst” is a converting coefficient for slip angle and steering torque, “Kd” is a differential gain, and (dθ/dt) is a time-variation of the slip angle (θ).

Thus, according to each embodiment as described above, with the braking force applied to each wheel being properly modified on the basis of the lateral acceleration (Gy), it is possible to prevent the improper behavior resulted from the braking force difference, which is caused by the varying load in the case where the braking operation is performed when the vehicle is turning, so that a desired characteristic for the vehicle can be maintained.

The embodiment for actively controlling the steered wheel angle as shown in FIG. 1 and the embodiment for controlling the assisting torque as shown in FIG. 8 may be applied together. However, if one of them is performed, it will sufficiently assist the counter-steer operation performed during a μ-cross over braking operation, in each embodiment. The embodiments as described above relate to the active front steering control system for the front steered wheels, while the present invention is applicable to the active rear steering control system for the rear steered wheels, and also applicable to a vehicle having both of the steering control systems.

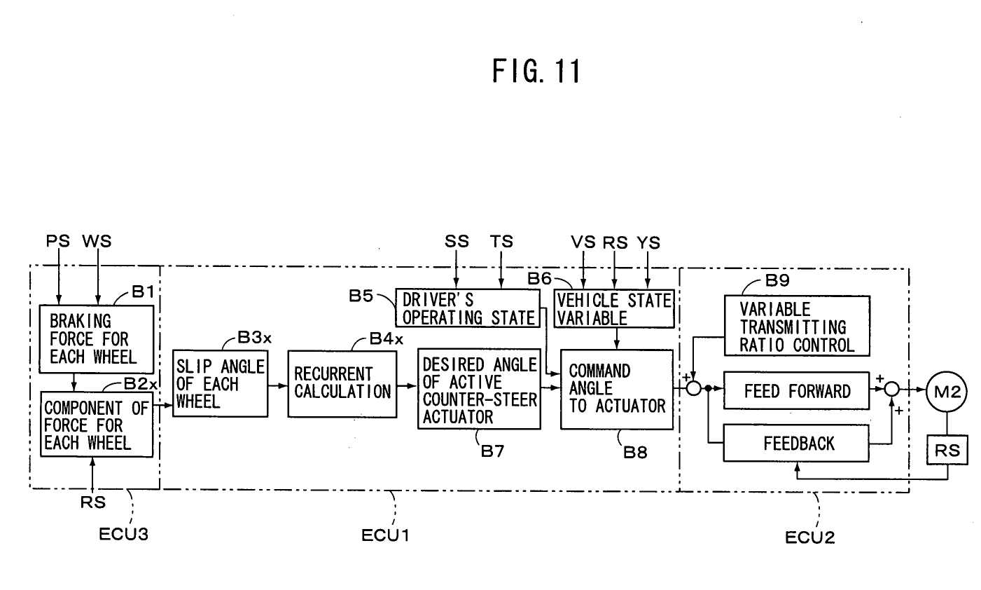

Next, referring to FIGS. 11-15, will be explained about the steering control apparatus according to a further embodiment of the present invention. FIGS. 1 and 2 are also applied to the further embodiment, while these figures and explanation are omitted herein, to avoid repetition of them. In FIG. 11, the blocks except for (B2x), (B3x) and (B4x) are substantially the same as those as shown FIG. 3, the explanation of them is omitted herein, with the same reference numerals given to substantially the same elements as shown in FIG. 3. The braking control unit ECU3 includes the braking force estimation block (B1) for estimating the braking force applied to each wheel, and a component of force estimation block (B2x) for estimating a component of the braking force applied to each wheel in the lateral (right-left) direction and the longitudinal (front-rear) direction of the vehicle. And, the steering control unit ECU1 includes a slip angle calculation block (B3x) for calculating a slip angle for each wheel, to cancel the moment about the gravity center of the vehicle caused by the braking force and lateral force applied to each wheel, on the basis of the result estimated at the component of force estimation block (B2x), and a recurrent calculation block (B4x) for performing at least one cycle of recurrent calculation to the slip angle calculated at the slip angle calculation block (B3x). And, the actuator desired angle setting block (B7) is provided for setting a desired angle to the actuator for the active counter-steer control, on the basis of the result of the recurrent calculation block (B4x). The remaining blocks are the substantially the same as those as shown FIG. 3, the explanation of them is omitted herein, with the same reference numerals given to substantially the same elements as shown in FIG. 3.

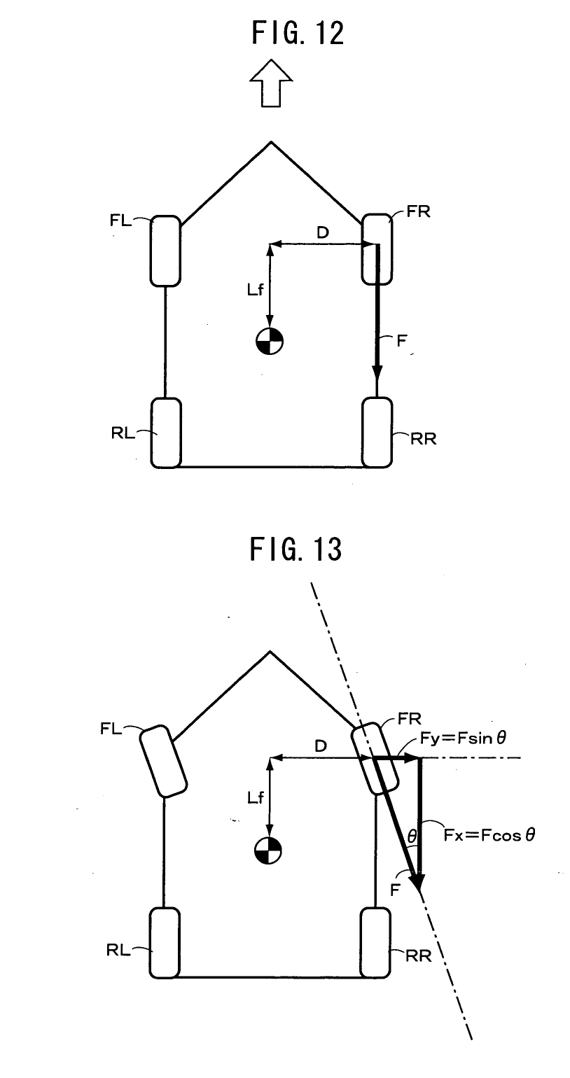

Referring to FIGS. 12 and 13, will be explained the moment as described above. Supposing that a vehicle is braked when the vehicle is moving in a direction as shown by a blank arrow in FIG. 12, so that braking force (F) is applied to one of the wheels to be steered, e.g., wheel FR, as shown in FIG. 12, then the vehicle is controlled according to such a steering control that braking force differences among four wheels will be balanced with the moment about the gravity center of the vehicle, to provide a steered wheel angle (tire angle) of “θ”. As a result of this steering control, if the wheel FR is turned by the angle (θ), the applied braking force (F) is divided into the longitudinal (front-rear) component (Fx=F·cosθ), and the lateral (right-left) component (Fy=F·sinθ). Therefore, a clockwise moment (M) as obtained by the following equation (22) is applied to the wheel FR, which is increased comparing with the clockwise moment (=F·D) as shown in FIG. 12.

$$\begin{matrix}M = ( F \cdot cos θ \cdot D ) + ( F \cdot sin θ \cdot Lf ) \\ = ( cos θ + sin θ \cdot Lf / D ) \cdot F \cdot D\end{matrix} \qquad ( 22 )$$

where “Lf” is a distance between the gravity center and the front axle, and “D” is 1/2 of tread.

Likewise, a counterclockwise moment (M) as obtained by the following equation (23) is applied to the wheel FL, which is decreased comparing with the counterclockwise moment as shown in FIG. 12.
M=(cos θ−sin θ·Lf/D)·F·D (23)

As a result of the steering control as described above, a balance between the moments is changed to reduce the steered wheel angle (tire angle), so that it is required to compensate for a lack of the steered wheel angle. According to the present embodiment, therefore, after a desired angle of steered wheel is calculated at first, a calculation is performed for obtaining a moment balance at the desired angle, without the desired angle being output immediately, and the latter calculation is repeated, if necessary, and then the actuator is driven to provide the desired angle of steered wheel, to ease the moment applied to the vehicle, appropriately.

In practice, the slip angle for each wheel for canceling the moment about the gravity center of the vehicle caused by the braking force and lateral force applied to each wheel is calculated at the slip angle calculation block (B3x), on the basis of the result estimated at the component of force estimation block (B2x), as shown in FIG. 11. And, at least one cycle of recurrent calculation to the calculated slip angle will be executed, at the recurrent calculation block (B4x), as described hereinafter. That is, on the basis of the braking force and lateral force (resulted from the actually steered wheel angle) applied to each wheel, the moment for rotating the vehicle about the gravity center thereof is calculated to obtain the steered wheel angle which may cause the lateral force corresponding to that moment. For the purpose of easy understanding, the initial steered wheel angle is set to be zero, so that a moment (M1) applied to the vehicle through the braking operation, with the braking force Ffl, Frl, Ffr and Frr being applied to each wheel, will be obtained as follows:
M1=(Ffl+Frl−Ffr−Frr)·D (24)

The slip angle (θ₁₁) for compensating the moment (M1) is obtained according to the following equation (26), to provide the desired angle of steered wheel, on the basis of the following equation (25) indicative of the moment balance.
θ₁₁·Ksf·Lf=M1 (25)
θ₁₁=M1/(Ksf·Lf) (26)
where “Ksf” is a converting coefficient for slip angle and lateral force with respect to the wheels FR and FL.

Next, when the recurrent calculation to the slip angle (θ₁₁) is executed at the recurrent calculation block (B4x), the moment (M2) applied to the vehicle becomes a value for reflecting the slip angle (θ₁₁) as shown in the following equation (27), on the basis of which a slip angle (θ₁) is obtained according to the following equation (28), to be set as the desired angle of steered wheel.
M2=Ffl·(cosθ₁−sinθ₁₁Lf/D)+Frl·D−Ffr·(cosθ₁₁+sinθ₁₁·Lr/D)+Frr·D (27)
θ₁=M2/(Ksf·Lf) (28)
where “Lf” is a distance between the gravity center and the front axle, “Lr” is a distance between the gravity center and a rear axle, and “D” is ½ of tread.

In the above-described embodiment, there is such a prerequisite condition that a vehicle slip angle (β) will not be caused. If the vehicle slip angle (β) is obtained, however, it may be reflected to the calculation of the wheel slip angle for each wheel. At the recurrent calculation block (B4x), the recurrent calculation is not limited to once, but also a plurality number of cycles may be made to repeat the recurrent calculation to obtain the slip angle (θ₁), which may be set as the steered wheel angle. According to the present embodiment, therefore, necessary steered wheel angles can be obtained appropriately, whereas it is impossible to obtain the steered wheel angle as required according to the prior apparatus for providing the steered wheel angle only on the basis of the braking force difference, due to lack of moment, which will be caused when the wheels to be steered are actually steered.

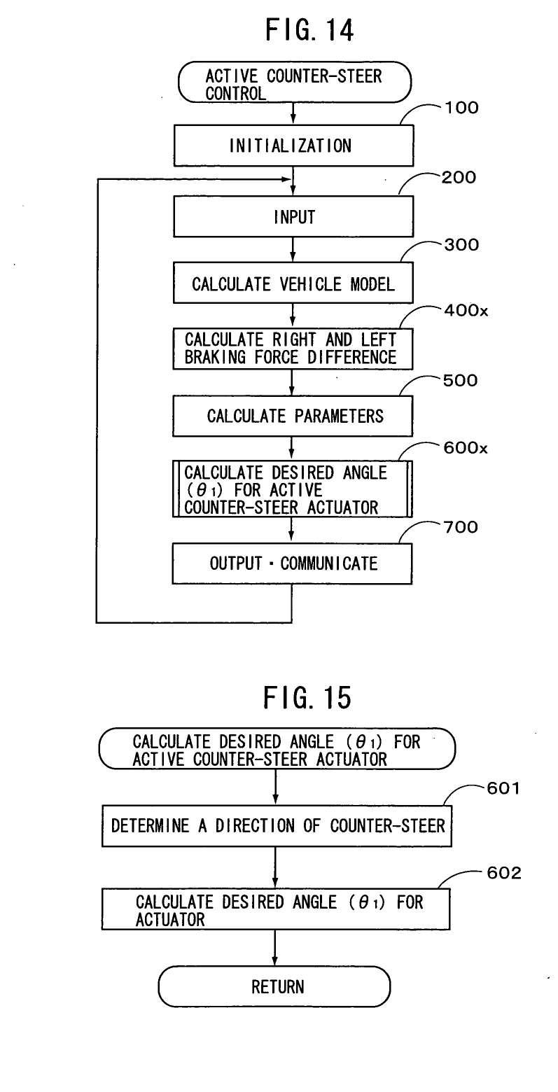

The steering control apparatus as constituted above is actuated to perform the active counter control in response to braking operation, when the vehicle is running on the μ-split road, for example, according to flowcharts as shown in FIGS. 14 and 15. At the outset, the program provides for initialization of the system at Step 100, and the sensor signals are input and the steered wheel angle, vehicle speed, longitudinal acceleration, lateral acceleration, yaw rate or the like are read at Step 200, and various data calculated at the braking control unit ECU3 are read as well, through the communication signals. Then, the program proceeds to Step 300 where a vehicle model is calculated, while its explanation is omitted herein. Next, at Step 400x, is calculated the braking force difference between the braking force applied to the right wheel FR and the braking force applied to the left wheel FL. Then, after various parameters are calculated at Step 500, the program proceeds to Step 600x where the desired angle (θ₁) of steered wheel is calculated for the actuator AC2 to perform the active counter-steer control. Consequently, the program proceeds to Step 700 where output process is made, and the information transmitting process is made.

FIG. 15 shows the calculation of the desired angle (θ₁) of steered wheel for the actuator AC2 to perform the active counter-steer control performed at Step 600x, wherein a counter-steer direction is determined at Step 601, on the basis of the output detected by the steering angle sensor SS. For example, provided that a neutral position of the sensor SS is set to be zero (0), a left turn is determined when the steering angle is of positive value, whereas a right turn is determined when the steering angle is of negative value. And, at Step 602, the desired angle (θ₁) of steered wheel for the actuator AC2 is obtained according to the equation of [θ₁=M2/(Ksf·Lf)], as described before. That is, the desired angle (θ₁) of steered wheel according to the present embodiment is appropriately calculated not only on the basis of the braking force difference between the right and left wheels, but also on the basis of variation of balance of the moment about the gravity center of the vehicle, which is determined by the braking force actually applied to each wheel, with the steered wheel angle being varied.

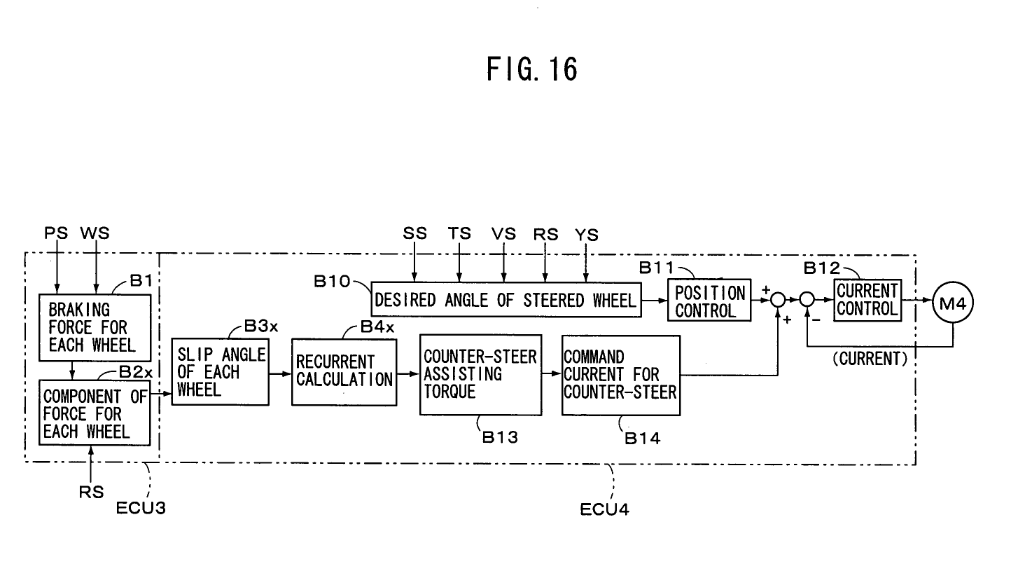

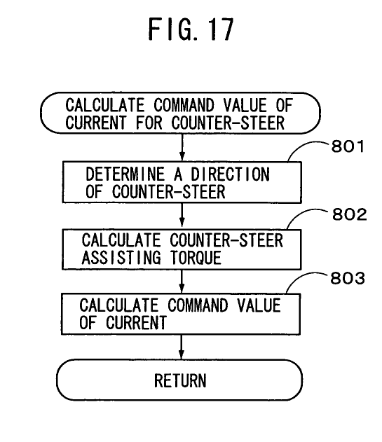

Next, referring to FIGS. 16 and 17, will be explained about the steering control apparatus according to a yet further embodiment of the present invention. FIGS. 8 and 9 are also applied to this embodiment, while these figures and explanation are omitted herein, to avoid repetition of them. In FIG. 16, as the blocks (B2x), (B3x) and (B4x) are substantially the same as those as shown in FIG. 11, the explanation of them is omitted herein. And, the remaining blocks are substantially the same as those as shown in FIG. 10, the explanation of them is omitted herein, with the same reference numerals given to substantially the same elements as shown in FIG. 10.

According to the present embodiment, the counter-steer assisting steering torque (τct) is calculated not only on the basis of the braking force difference between the right and left wheels, but also on the basis of variation of balance of the moment about the gravity center of the vehicle, which is determined by the braking force actually applied to each wheel, and which is set on the basis of [θ₁=M2/(Ksf·Lf)], as follows:
τct=θ₁·Kst (29)
τct=θ₁·Kst+Kd·(dθ1/dt)·Kst (30)
where “Kst” is a converting coefficient for slip angle and lateral force, “Kd” is a differential gain, and (dθ₁/dt) is a time-variation of the slip angle (θ₁).

According to the embodiment as constituted above, when the active counter control is performed during the braking control, the current command value for performing the counter-steer assisting control, instead of Step 600x in the flowchart as shown in FIG. 14. The remaining steps are substantially the same as those in FIG. 14, so that the explanation of them are omitted herein. The current command value for performing the counter-steer assisting control is calculated according to the flowchart as shown in FIG. 17. At the outset, the counter-steer direction is determined at Step 801, and the counter-steer assisting steering torque (τct) is obtained at Step 802 according to the equation of [τct=θ₁·Kst], as described before. That is, the counter-steer assisting steering torque (τct) is appropriately calculated not only on the basis of the braking force difference between the right and left wheels, but also on the basis of variation of balance of the moment about the gravity center of the vehicle, which is determined by the braking force actually applied to each wheel, with the steered wheel angle being varied. Then, the program proceeds to Step 803, where the current command value for performing the counter-steer assisting control with respect to the electric motor M4 is calculated on the basis of the counter-steer assisting steering torque (τct) as obtained above.

Although the steered wheel angle to be provided as the desired angle is calculated on the basis of a dynamic calculation, according to the above-described embodiment, an approximate conversion map may be provided in advance, on the basis of which the desired angle of steered wheel may be calculated. In this case, the slip angle (θ₁₁) may be used for the map, to obtain the slip angle (θ₁). Also, the embodiment for actively controlling the steered wheel angle as shown in FIG. 1 and the embodiment for controlling the assisting torque as shown in FIG. 8 may be applied together. However, if one of them is performed, it will sufficiently assist the counter-steer operation performed during the μ-cross over braking operation in each embodiment. The embodiments as described above relate to the active front steering control system for the front steered wheels, while the present invention is applicable to the active rear steering control system for the rear steered wheels, and also applicable to a vehicle having both of the steering control systems.

It should be apparent to one skilled in the art that the above-described embodiment are merely illustrative of but a few of the many possible specific embodiments of the present invention. Numerous and various other arrangements can be readily devised by those skilled in the art without departing from the spirit and scope of the invention as defined in the following claims.

1. A steering control apparatus for a vehicle, comprising:
steering control means for controlling a steered wheel angle of a wheel to be steered in response to steering operation of a vehicle driver;
braking force estimation means for estimating a braking force applied to each of at least a pair of right and left wheels of said vehicle, respectively;
lateral acceleration detection means for detecting a lateral acceleration of said vehicle;
braking force modification means for calculating a variation of braking force resulted from a varying load applied to each of said right and left wheels on the basis of the lateral acceleration detected by said detection means, when said vehicle is turning, and modifying the braking force estimated by said braking force estimation means, on the basis of the variation of braking force; and
steered wheel angle setting means for setting the steered wheel angle of said wheel to be steered, to cancel a moment about a gravity center of said vehicle, on the basis of the braking force modified by said braking force modification means.

2. The steering control apparatus according to claim 1, further comprising vehicle behavior determination means for determining at least an understeer state of said vehicle, wherein said braking force modification means modifies the variation of braking force resulted from the varying load applied to each of said right and left wheels, on the basis of the understeer state of said vehicle determined by said vehicle behavior determination means, to modify the braking force applied to each wheel.

3. The steering control apparatus according to claim 2, wherein said braking force modification means modifies the variation of braking force resulted from the varying load applied to each of said right and left wheels, by a relatively large amount, when the understeer state of said vehicle determined by said vehicle behavior determination means is in the vicinity of a neutral-steer state of said vehicle, and wherein said braking force modification means modifies the variation of braking force by a smaller amount, with the understeer state of said vehicle being varied to be larger.

4. The steering control apparatus according to claim 2, wherein said braking force modification means modifies the variation of braking force resulted from the varying load applied to each of said right and left wheels, to be of such a predetermined value that the understeer state of said vehicle determined by said vehicle behavior determination means is in the vicinity of the neutral-steer state of said vehicle.

5. A steering control apparatus for a vehicle, comprising:
steering torque applying means for applying a steering torque to a wheel to be steered in response to steering operation of a vehicle driver;
braking force estimation means for estimating a braking force applied to each of at least a pair of right and left wheels of said vehicle, respectively;
lateral acceleration detection means for detecting a lateral acceleration of said vehicle;
braking force modification means for calculating a variation of braking force resulted from a varying load applied to each of said right and left wheels on the basis of the lateral acceleration detected by said detection means, when said vehicle is turning, and modifying the braking force estimated by said braking force estimation means, on the basis of the variation of braking force; and
steering torque setting means for setting the steering torque of said wheel to be steered, to cancel a moment about a gravity center of said vehicle, on the basis of the braking force modified by said braking force modification means.

6. The steering control apparatus according to claim 5, further comprising vehicle behavior determination means for determining at least an understeer state of said vehicle, wherein said braking force modification means modifies the variation of braking force resulted from the varying load applied to each of said right and left wheels, on the basis of the understeer state of said vehicle determined by said vehicle behavior determination means, to modify the braking force applied to each wheel.

7. The steering control apparatus according to claim 6, wherein said braking force modification means modifies the variation of braking force resulted from the varying load applied to each of said right and left wheels, by a relatively large amount, when the understeer state of said vehicle determined by said vehicle behavior determination means is in the vicinity of a neutral-steer state of said vehicle, and wherein said braking force modification means modifies the variation of braking force by a smaller amount, with the understeer state of said vehicle being varied to be larger.

8. The steering control apparatus according to claim 6, wherein said braking force modification means modifies the variation of braking force resulted from the varying load applied to each of said right and left wheels, to be of such a predetermined value that the understeer state of said vehicle determined by said vehicle behavior determination means is in the vicinity of the neutral-steer state of said vehicle.

9. A steering control apparatus for a vehicle, comprising:
steering control means for controlling a steered wheel angle of a wheel to be steered in response to steering operation of a vehicle driver;
braking force estimation means for estimating a braking force applied to each of at least a pair of right and left wheels of said vehicle, respectively;
lateral force estimation means for estimating a lateral force applied to each of said right and left wheels;
slip angle calculation means for calculating a slip angle for each of said right and left wheels, to cancel a moment about a gravity center of said vehicle caused by the braking force and lateral force applied to each of said right and left wheels, on the basis of the results estimated by said braking force estimation means and said lateral force estimation means; and
steered wheel angle setting means for setting the steered wheel angle of said wheel to be steered, on the basis of the slip angle calculated by said slip angle calculation means.

10. The steering control apparatus according to claim 9, wherein said slip angle calculation means includes recurrent calculation means for performing at least one cycle of recurrent calculation to the slip angle calculated by said slip angle calculation means, to substitute the result calculated by said recurrent calculation means for the slip angle calculated by said slip angle calculation means.

11. A steering control apparatus for a vehicle, comprising:
steering torque applying means for applying a steering torque to a wheel to be steered in response to steering operation of a vehicle driver;
braking force estimation means for estimating a braking force applied to each of at least a pair of right and left wheels of said vehicle, respectively;
lateral force estimation means for estimating a lateral force applied to each of said right and left wheels;
slip angle calculation means for calculating a slip angle for each of said right and left wheels, to cancel a moment about a gravity center of said vehicle caused by the braking force and lateral force applied to each of said right and left wheels, on the basis of the results estimated by said braking force estimation means and said lateral force estimation means; and
steering torque setting means for setting the steering torque of said wheel to be steered, on the basis of the slip angle calculated by said slip angle calculation means.

12. The steering control apparatus according to claim 11, wherein said slip angle calculation means includes recurrent calculation means for performing at least one cycle of recurrent calculation to the slip angle calculated by said slip angle calculation means, to substitute the result calculated by said recurrent calculation means for the slip angle calculated by said slip angle calculation means.
